(19) United States
(12) Patent Application Publication
(10) Pub. No.: US 2008/0275803 A1
(43) Pub. Date: Nov. 6, 2008

(54) METHOD FOR CAPTURING FINANCIAL SAVINGS FROM A COLLECTIVE THROUGH ISSUING AND SELLING OF ELECTRONIC CARDS

(75) Inventor: Denner Antonio DA SILVA, Rio de Janeiro (BR)

Correspondence Address: EGBERT LAW OFFICES, 412 MAIN STREET, 7TH FLOOR, HOUSTON, TX, 77002, US

(73) Assignees: Denner Antonio DA SILVA, Rio de Janeiro (BR); Brunswick Consultores Associados Com. E Repr. Ltda, Rio de Janeiro (BR)

(21) Appl. No.: 11/744,206

(22) Filed: May 3, 2007

(51) Int. Cl. G06Q 40/00

(52) U.S. Cl. 705/35

(57) ABSTRACT

Business method for capturing popular saving with issue of credit papers with variable monetary values that can receive prizes and be redeemed for cash, good(s) or service(s) from a network of stores and companies.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention refers to a business method that captures financial savings from a collective through issuing and selling of electronic cards.

2. Description of Related Art Including Information Disclosed Under 37 CFR 1.97 and 37 CFR 1.98.

Most governments, in the course of their actions, have implemented projects aimed at improving the quality of life of the poorer people. However, these actions are confronted with macroeconomic situations, avoiding credit at very high levels so as not to cause overheating in consumption and, consequently, an increase in inflation levels. Aware of this, governments focus their actions on social projects that meet especially “Physiological Needs”, failing to attend to other important needs that can provide significant improvements in the quality of life of these people.

This project allows any government to achieve its objective of improving the quality of life of these people without running macroeconomic risks. Moreover, it starts to answer the “Needs of Self-Esteem”, the second most important need in the Quality of Life pyramid.

Collective savings funding has been done in different ways around the world. The resources of distribution of prizes and redemptions after the grace period have been known and used for many years.

Redemption resources with cash and/or goods have also been used. All known variations are implemented by an issuing body and by points (of sale) or stores accredited by the issuing body. The methods known do not apply to a multiplicity of points or stores accredited by origin, business area and different properties, as a result of the difficulty in controlling the entire system.

### BRIEF SUMMARY OF THE INVENTION

The present invention refers to a business method that captures financial savings from a collective through the issue and sale of electronic cards, by duly qualified and accredited institutions. These cards have different monetary values, which allow their holders to receive prizes in cash and/or goods through lotteries and to make their redemptions in cash and/or goods, after pre-established grace periods, in previously member stores, which, in turn, make their redemptions by monetary values at the financial institutions responsible for their generation.

### BRIEF DESCRIPTION OF THE SEVERAL VIEWS OF THE DRAWINGS

The present invention will be better understood referring to the accompanying drawing.

FIG. 1 is a schematic view of the range of the method of operation of the present invention.

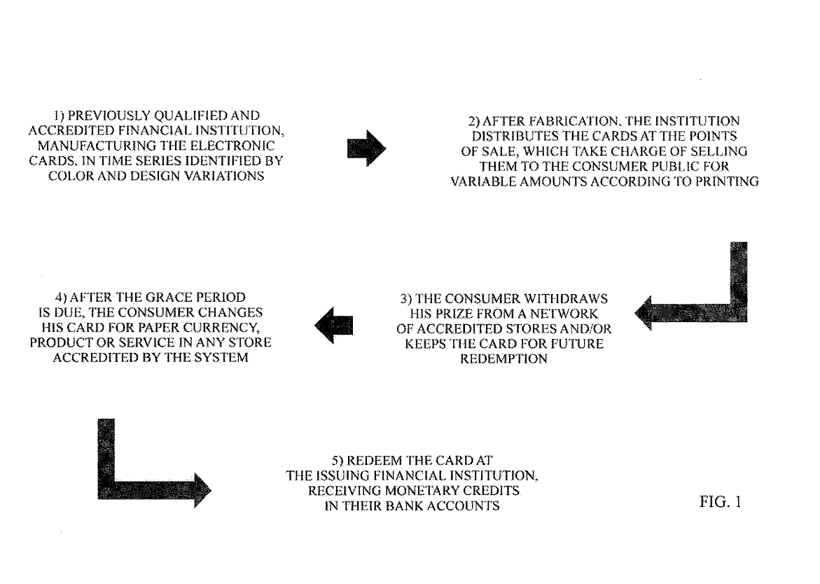

### DETAILED DESCRIPTION OF THE INVENTION

The present invention introduces the possibility of covering all these variations in a single method. The preferred implementation of the method begins with the previously qualified and accredited financial institution, manufacturing the electronic cards, in time series identified by color and design variations. The cards contain fields that are not visible at first sight, which enable the distribution of prizes, after the visualizations by magnetic strip or any other identification medium. After fabrication, the institution distributes the cards at the points of sale, which take charge of selling them to the consumer public for variable amounts according to printing. The consumer withdraws his prize from a network of accredited stores and/or keeps the card for future redemption. After the grace period is due, the consumer changes his card for paper currency, products or services in any store accredited by the system, and the latter, in turn, redeems the card at the issuing financial institution, receiving monetary credits in their bank accounts. The institution may subtract administration fees.

The method can also be applied for specific issues and transactions, with different card issuing bodies, from financial institutions to business companies and government bodies, and with different electronic cards. The cards can be directed for exchange of specific and/or generic goods from a single source or network of sources, for distribution of specific prizes, or for capture and redemption of scheduled savings. They can also interact with other systems of the credit card and/or travelers check type, permitting further the inclusion of advertisement on the cards. The application of this method causes an increase in the level of internal savings, at the same time providing better life conditions to low-income populations. The objective can be summarized as offering a new option of capturing popular savings that allows people to save resources more freely and spontaneously, and aiming at acquiring products and services of their choice on a future date.

Improvements in indices considered fundamental from the social, political and economic aspects of the Public Administration are provided as follows:

1. Increase in the Internal Savings Index and strengthen the Trade Industry. The present invention causes an increase in consumption without an increase in inflation, and without the need to waive resources for popular credit, strengthening of trade with increased sales and strengthening of industry with increased production;

2. Improvement in the quality of life of lower income brackets. The present invention removes the need to release credit and with zero default; and

3. Political strengthening, especially with the classes that benefit most. The present invention increases customer loyalty to electors from popular classes due to improvements provided for the quality of their lives, and customer loyalty to class “A” and “B” electors as a result of improvements in the trade and industry results, growth of profits, salaries and jobs.

1. Business method that captures financial savings from a collective by issuing and selling credit papers with different monetary values by an institution for use by the public in general which can exchange them after some time by different goods or services in a multiplicity of points or stores accredited by origin, business area and different properties or by another amount from the initial institution having those credit papers the possibility of giving prizes to the public and reserve part of the monetary value in benefit of benevolence houses and being the credit papers redeemable on the initial institution by the multiplicity of points or stores.
